(19) United States
(12) Patent Application Publication
(10) Pub. No.: US 2007/0086399 A1
(43) Pub. Date: Apr. 19, 2007

(54) METHOD FOR ACQUIRING POSITIONAL INFORMATION ON A WIRELESS TERMINAL BY PERIODICALLY TRANSMITTING A DATA TRANSMISSION REQUEST

(75) Inventor: Hiroyuki Akiyama, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/464,965

(22) Filed: Aug. 16, 2006

(30) Foreign Application Priority Data
Aug. 16, 2005 (JP) JP2005-235904

(51) Int. Cl. H04Q 7/24

(52) U.S. Cl. 370/338

(57) ABSTRACT

A method for acquiring positional information on a wireless terminal station set to its power-saving mode. The access point uses stored-data information in a beacon frame to inform the station applied with the power-saving mode of the presence of stored data regardless of whether or not the stored data exists. The station involved in its dose condition will enter its awake condition immediately before the beacon frame timing to receive a beacon frame. The station then checks the stored-data information and transmits a stored-data request frame to the access point. The access point transmits a data frame if stored data exists, or transmits a null frame if no data is stored. If no stored-data request frame is received within a predetermined time period, the access point determines that the station has moved out of its service area, cancels the registration of the station, and deletes the stored data, if any.

### BACKGROUND OF THE INVENTION

1. Field of the Invention

The present invention relates to a process for acquiring positional information on a wireless terminal station which moves between access points in a wireless local area network (LAN) or the like formed by a plurality of access points or base stations.

2. Description of the Background Art

For the wireless LAN, general background art may be taught by, for example, Japanese patent laid-open publication No. 2003-259417, and “ANSI/IEEE Std802.11, 1999 Edition Wireless LAN Medium Access Control (MAC) and Physical Layer (PHY) Specifications”.

Reference will first be made to FIG. 2, which is a schematic diagram showing a wireless LAN system. The wireless LAN includes two types of wireless LANs: the infrastructure networks BSS1, BSS2 and BSS3 and extended wireless network ESS. The infrastructure networks BSS1, BSS2 and BSS3 are wireless LANs in a narrow sense, and each have one access point AP1, AP2 or AP3, respectively, serving as the center and a plurality of terminal stations STA. The extended wireless network ESS is a wireless LAN in a broad sense, and has access points AP1 and AP2 each forming an infrastructure network, the access points being interconnected through the inter-access point lines ECH.

The infrastructure network BSS1, for example, includes the access point AP1 and a plurality of stations STA whose functions are implemented by PC (Personal Computer) cards or the like. Many of the access points may be mounted high on a ceiling, wall or the like of a building so that the wireless signal can reach a wider wireless area in which more stations STA can be served. A single frequency is used to transmit and receive wireless signals. The CSMA/CA (Carrier Sense Multiple Access/Collision Avoidance) scheme is thus employed. According to the scheme, it is checked before transmission whether or not the frequency is in use. If the frequency is in use, it is not used in multiple for the new transmission to avoid collision. The scheme thus allows a number of stations STA to transmit and receive without interference in the infrastructure network BSS1 or BSS2.

The infrastructure networks BSS1 and BSS2 provide communication only between respective access points and stations. Specifically, any two stations do not directly communicate with each other but the access point must intervene between them for their communication. The type of wireless LAN without having an access point fixed, referred to as the ad hoc network, has stations which alternately serve concurrently as an access point. The ad hoc network thus controls the transmitting and receiving basically in the same way as in the infrastructure network BSS1 or BSS2.

The access point AP1 or AP2 communicates with mobile stations STA existing in the infrastructure network BSS1 or BSS2, respectively. The access point APl or AP2 can thus relay or transfer communication data to another station STA staying in the same network or to a mobile station staying in other network. To a station residing in another network, data will be relayed in the following fashion. The station STA sends data to the access point AP1, for example. The access point AP1 then transfers the data to another access point AP2 over the inter-access point line ECH which connects the access points AP1 and AP2. The other access point sends the data to the station in the network to which the data is to be transferred.

Now, further reference will be made to FIG. 3, which illustrates the power-saving control sequence of a conventional wireless LAN. The access point, AP1 or AP2, transmits a beacon frame B at a constant transmission interval T. The beacon frame B is a communication frame mainly for advertising the wireless-area information to all stations within the wireless area. The beacon frame B is broadcast to all stations. The beacon frame B indicates, under the power-saving management, whether or not it keeps data addressed to a station now involved in its power-saving mode.

The station which wishes the power-saving operation uses a part of a data frame D to be transmitted to the access point to send the power-saving mode application request. The access point in turn transmits to the station a response frame A indicating that the access point accepts the transition to the power-saving mode. Since then, the access point shifts its control so as not to transmit to the station any transmission data addressed to that station but store the data in its memory. Using the stored-data information in the beacon frame B subsequently transmitted, the access point further informs the station in a dose condition whether or not the stored data for the station exists. The dose condition means that the electric power of the station is saved by, for example, stopping the clock provided to its transmitting and receiving circuit, or by shutting off the power supply. Note that the normal operating condition is referred to as the awake condition in contrast to the dose condition.

When the station receives from the access point the response frame A indicating that the access point accepts the registration in the power-saving mode, it transitions to its power-saving mode to be in its dose condition. The station in the dose condition will enter the awake condition immediately before the next beacon frame B is transmitted, waiting for that beacon frame B. The station checks the stored information in the received beacon frame B to determine whether or not data addressed to the station is stored.

When the stored information indicates that stored data is not addressed to the station, the station immediately returns to the dose condition. When the information indicates that stored data is addressed to the station, the station transmits a stored-data request (PS-Poll) frame P to the access point, thus requesting the stored data to be transmitted.

The access point responds to the stored-data request frame P to transmit to the station the response frame A and then the stored data in the form of data frame D. The data frame D contains information (More Data Field) about whether or not other data remains stored. While checking the information in the data frame D received, the station repeats transmitting the stored-data request frame P until the station receives all stored data. After receiving all stored data, the station returns to the dose condition. In this way, alternately repeating the dose condition and awake condition allows for the power-saving operation of the station.

The recent wireless LANs encounter a demand for data communication dedicated in the narrow wireless area, as well as an increasing demand for the voice communication using the VoIP (Voice over Internet Protocol) technology. Stations that function as cellular phones thus become commercially available. The mobile station including such a cellular phone function is not used dedicatedly in the narrow wireless area of one infrastructure network BSS but in the extended wireless network ESS where a calling party and a called party reside in the wireless areas served by different access points. Further, the mobile station keeps the communication with the access points during moving, and therefore the mobile station needs to appropriately select the access point to connect to.

For the extendwireless network ESS that contains the mobile stations that perform the power-saving operations, however, the access point cannot grasp whether the station exists in its wireless area or the station has moved into another wireless area. Particularly, when the station has moved into another wireless area, it is difficult for the access point to transfer information on the incoming call to the mobile station.

In this way, the mobile station in the dose condition will periodically enter the awake condition at a constant time interval to receive the beacon frame and checks the stored-data information. When no stored data exists, the station returns to the dose condition without transmitting anything. During repetition of such conditions, when the station moves into another wireless area, it receives the beacon frame from another access point. The beacon frame from the other access point then contains no stored-data information on that station. The station then determines that no stored data exists, and alternately repeats the dose and awake conditions without transmitting anything. That will cause the station finally to move to a location completely away from the access point where the station is registered in the power-saving mode, so that no access point can grasp the location of that station.

If the station is not registered in the power-saving mode, the access point managing the station which returns no response can request other access points in the extend wireless network ESS to search for that station, and can transfer the management right to the access point which the station has moved to. If the station is registered in the power-saving mode, however, no response from the station is assumed, so that the search for the station is not requested. There is therefore a problem that it is difficult to respondto communication such as voice communication, which requires a quick response.

### SUMMARY OF THE INVENTION

It is an object of the present invention to provide a method for acquiring positional information on a wireless terminal station to grasp the position of the station set to its power-saving mode.

The present invention provides a method for acquiring positional information on a wireless terminal station in a wireless system, the wireless system including an access point and a plurality of wireless terminal stations communicating with the access point, the access point periodically transmitting a beacon frame at a predetermined time interval, a wireless terminal station set to apower-savingmode entering into a normal-operationmode at a timing of the beacon frame being transmitted to receive the beacon frame, the wireless terminal station sending a stored data transmission request to the access point when stored-data information in the beacon frame indicates presence of stored data addressed to the wireless terminal station.

In accordance with the present invention, the access point first transmits the beacon frame including the stored-data information indicating the presence of the stored data addressed to the wireless terminal station set to the power-saving mode, regardless of whether or not stored data exists. The wireless terminal station then transmits, after receiving the stored-data information, a stored data transmission request to the access point.

The access point recognizes, after receiving the stored data transmission request, the presence of the wireless terminal station, and transmits stored data if the data actually exists or transmits dummy data if no data is stored. The wireless terminal station then returns to the power-saving mode, after receiving the stored data or dummy data transmitted from the access point.

The access point determines, when failing to receive a stored-data transmission requestfrom thewireless terminal station within a predetermined period of time after transmitting the beacon frame, that the wireless terminal station has moved out of the wireless service area of the access point, and deletes the registration of the wireless terminal station.

According to the present invention, the access point transmits a beacon frame including stored-data information indicating the presence of stored data addressed to the wireless terminal station set to the power-saving mode, regardless of whether or not stored data exists. Therefore, even when the wireless terminal station is set to the power-saving mode, the station needs to send a stored data transmission request to the access point. When the access point fails to receive a stored-data transmission request from the wireless terminal station within a predetermined period of time, the access point can determine that the wireless terminal station has moved out of the wireless area and delete the registration or the like.

### BRIEF DESCRIPTION OF THE DRAWINGS

The objects and features of the present invention will become more apparent from consideration of the following detailed description taken in conjunction with the accompanying drawings in which:

FIG. 1 illustrates the sequence of acquiring the positional information on a terminal station in an illustrative embodiment according to the present invention;

FIG. 2 is the schematic diagram showing a wireless LAN to which the present invention is applied;

FIG. 3 illustrates the power-saving control sequence of a conventional wireless LAN;

FIG. 4 illustrates another example of the sequence of acquiring the positional information on a terminal station according to the present invention;

FIG. 5 illustrates still another example of the sequence of acquiring the positional information on a terminal station according to the present invention; and

FIG. 6 illustrates the power-saving control sequence of the wireless LAN according to the present invention.

### DESCRIPTION OF THE PREFERRED EMBODIMENT

For a wireless or radio transmission system formed by a plurality of access points and a network connecting the access points, when a relevant access point transmits a beacon frame and thereafter a stored-data transmission request is not received from a wireless terminal station within a predetermined period of time, the access point can determine that the wireless station has moved out of the wireless area served by that access point and can request other access points to search for the wireless station.

The above-described and other objects and novel features of the invention will become more fully apparent upon reading the following description of a preferred embodiment in conjunction with the accompanying drawings. Note that the drawings are intended for the purpose of illustration only and not to limit the scope of the invention.

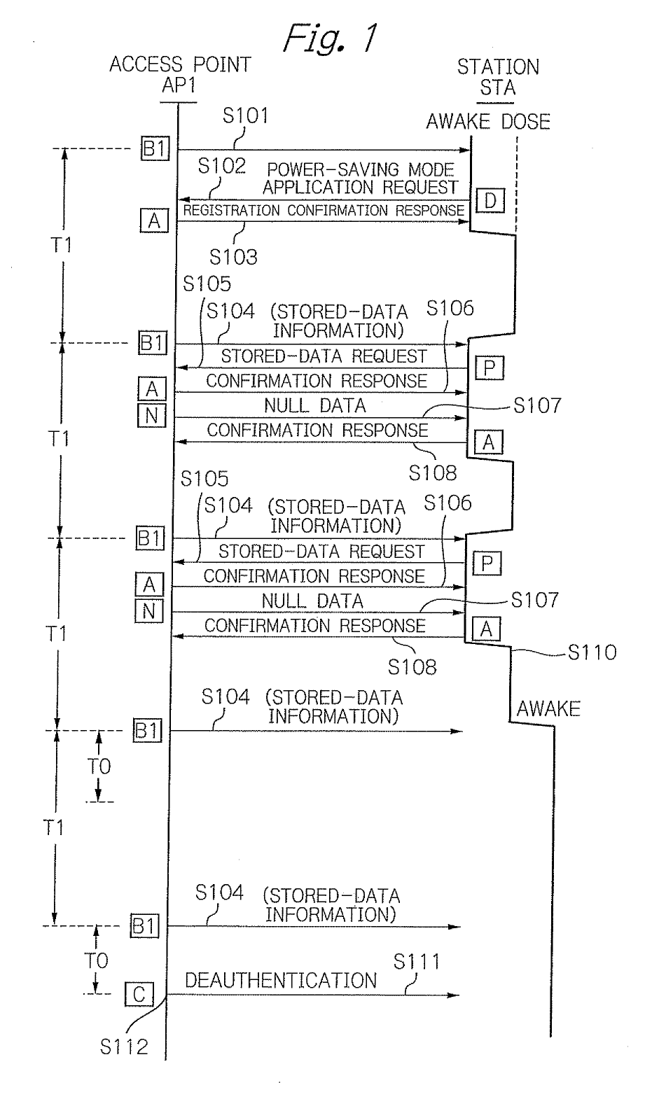

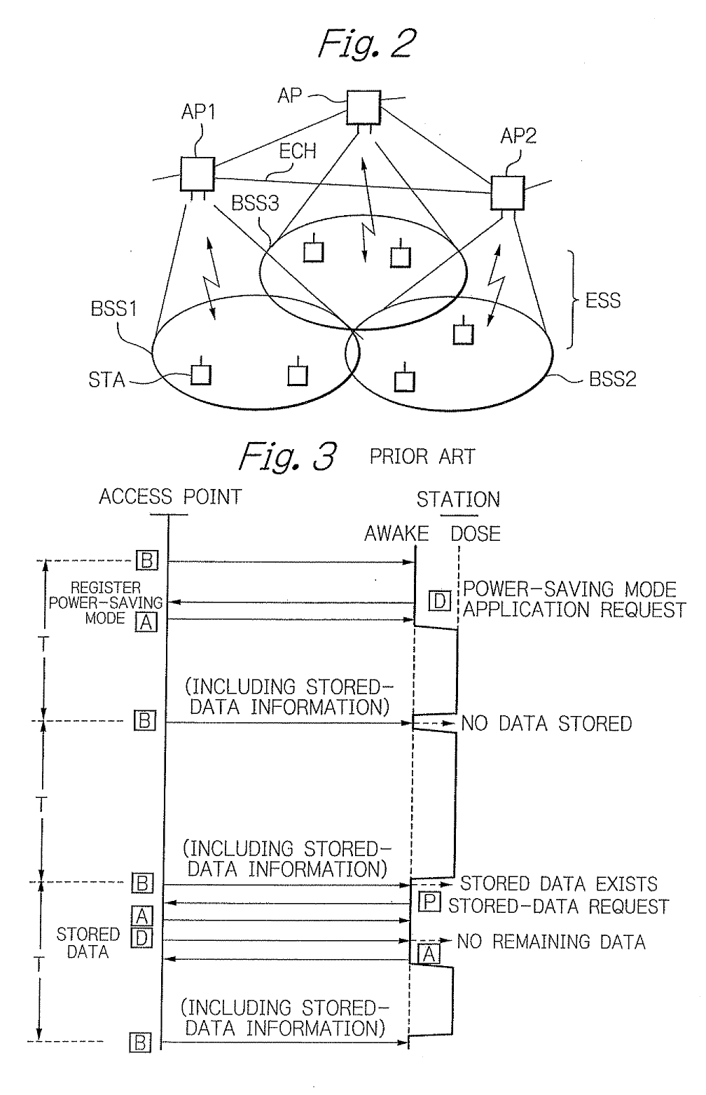

With reference to FIG. 1, description will be made on the sequence of acquiring positional information on a mobile terminal or station in the preferred embodiment according to the present invention. The station STA resides in the wireless area BSS1, FIG. 2, of a base station or access point AP1. In step S101, the access point AP1 periodically transmits a beacon frame B1 at a predetermined, constant transmission interval T1, which may be equal to, for example, 50 ms or 100 ms. The station STA is in its awake condition under the management by the access point AP1.

The station STA, when wishing its power-saving operation, uses a part of a data frame D to be transmitted to the access point AP1 to send a power-saving mode application request, step S102. The access point AP1 accepts the transition to the power-saving mode, and registers the station STA as the power-saving mode applied station. The access point AP1 then transmits a registration confirmation response frame A to that station STA, step S103. When the station STA receives from the access point AP1 the registration confirmation response frame A, it transitions to its power-saving mode to be in its dose condition.

The access point AP1 shifts its control so that it stores in its memory transmission data addressed to the station STA staying in the dose state without transmitting the data and uses the stored-data information included in the beacon frame B1 to be subsequently transmitted to prompt the station STA in the dose condition to inform whether or not the station STA has any data stored. With the exemplified sequence, the stored-data information indicating the presence of the stored data is always transmitted, regardless of whether or not the stored data exists.

The station STA in the dose condition will enter the awake condition immediatelybefore the nextbeacon frame B1 is transmitted, then waiting for that beacon frame B1, step S104. The station STA checks the stored information in the received beacon frame B1 for determining whether or not data addressed to the own station STA is stored. Because the stored-data information indicates the presence of the stored data in the instant example, the station STA transmits to the access point AP1 a stored-data request frame P which requests the stored data to be transmitted, step S104.

The access point AP1 transmits, in response to the stored-data request frame P received, a confirmation-response frame A to the station STA, step S106. If the stored data actually exists, then the access point AP1 transmits the data in the form of data frame D. If not, the access point AP1 transmits a null frame N, step S107. The data frame D contains information about whether or not other data remains stored. Checking the information in the data frame D received, the station STA repeats transmitting the stored-data request frame P until the station STA receives all stored data. After having received all stored data or the null frame N, the station STA transmits the confirmation-response frame A to the access point AP1 and then returns to the dose condition, step S108.

In this way, alternately repeating the dose and awake conditions allows for the power-saving operation of the station STA. The access point AP1 can confirm, by transmitting the beacon frame B1 and thereafter receiving the stored-data request frame P from the station STA, that the station STA resides in its service area.

The station STA will now move away from the wireless area of the access point AP1 into an area of another access point or beyond the area BSS1 served by the access point AP1, step S110. As described above, at the timing for receiving the beacon frame B1 from the access point AP1, the station STA enters the awake condition to wait for the beacon frame B1. The station STA is, however, out of the wireless area BSS1 of the access point AP1, so that it cannot receive the expected beacon frame B1.

When the access point AP1 several times fails to receive the stored-data request frame P from the station STA within a predetermined period of time T0, it determines that the station STA has moved out of its area BSS1, and transmits a deauthentication frame C to the station STA, step S111. Thereafter, regardless of whether or not the response from the station STA returns, the access point AP1 cancels the registration of the station STA, and deletes the stored data, if any, step S112.

As described above, in the sequence of acquiring the positional information on a terminal station in the instant example, in order to confirm the presence of the station STA which stays in its dose condition, the access point AP1 transmits the beacon frame B1 which includes the stored-data information indicating that data is stored even when no data for the station STA is stored. When the access point AP1 receives no stored-data request frame P from the station STA, it determines that the station STA has moved out of its access point area, and cancels the registration of the station STA. The accesspoint AP1 can thus always grasp the presence of the station STA involved in the dose condition. When the station STA has moved out of the area of the access point AP1, the registration of the station STA is cancelled, thereby reducing the load of the access point AP1.

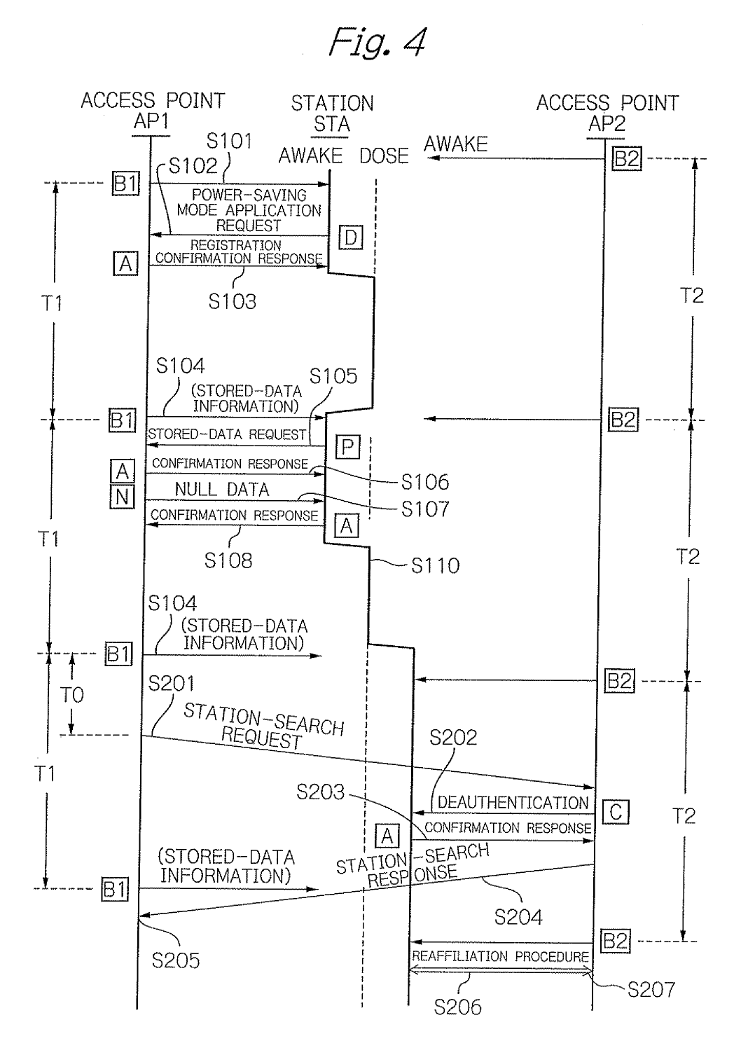

FIG. 4 illustrates anther exemplified sequence of acquiring the positional information on a terminal station according to the present invention. This sequence is the same as in FIG. 1 from step S101 until the station STA moves out of the wireless area of the access point AP1 and the access point AP1 detects no response from the station STA to determine that the station STA has moved out of its area, step S110. Like steps or elements are designated with the same reference numerals and a redundant will not be repeated for simplicity.

In the step S110, the station STA has moved away from the wireless area of the access point AP1 into the wireless area of another access point AP2, FIG. 2. At the timing of receiving the beacon frame B1 from the access point AP1, the station STA enters the awake condition, waiting for the beacon frame B1. The station STA is, however, out of the wireless area of the access point AP1, so that it cannot receive the beacon frame B1. The station STA thus remains in the awake condition, keeping waiting for the beacon frame B1.

The access point AP1 determines, when failing to receive a stored-data request frame P from the station STA within the predetermined period of time T0, that the station STA has moved out of its service area. The access point AP1 then sends a station-search request to the other access point AP2 over the extend wireless network ESS, step S201. The access point AP1 informs the access point AP2 of the address of the station STA to be searched for, and the address and identification code of the access point AP1.

After receiving the station-search request, the access point AP2 transmits, instead of the access point AP1, a deauthentication frame C to the station STA, step S202. The deauthentication frame C uses the address of the station STA to be searched for, and the address and identification code of the access point AP1, which are informed by the access point AP1.

The station STA that resides in the wireless area of the access point AP2 will know that the station STA is cancelled by the access point AP1 and transmit a confirmation-response frame A, step S203. The access point AP2 knows, when receiving the confirmation-response frameAfrom the station STA, that the station STA resides in its service area, and transmits a station-search response to the access point AP1 over the extend wireless network ESS, step S204.

The access point AP1 recognizes, from the station-search response, that the station STA has moved into the access point AP2 area, and deletes the registration of the station STA, step S205. The station STA performs, after having its registration cancelled from the access point AP1 in response to the deauthentication frame C, a reaffiliation procedure to the access point AP2, step S206. The station STA is then registered in the access point AP2 and can continue the communication, step S207.

If no station-search response returns from the access point AP2, however, the access point AP1 then transmits the station-search request to another access point to search for the station STA position.

As described above, in the thus exemplified sequence of acquiring the positional information on a terminal station, in order to confirm the presence of the station STA involved in the dose condition, the access point AP1 transmits the beacon frame B1 which includes the stored-data information indicating that the stored data exists, even when no data for the station STA is stored. The access point AP1 determines, when failing to receive a stored-data request frame P from the station STA, that the station STA has moved into another access point area, and searches for the station STA. The access point AP1 can thus always grasp the position of the station STA involved in the dose condition, thereby responding to the communication such as the voice communication which requires a quick response.

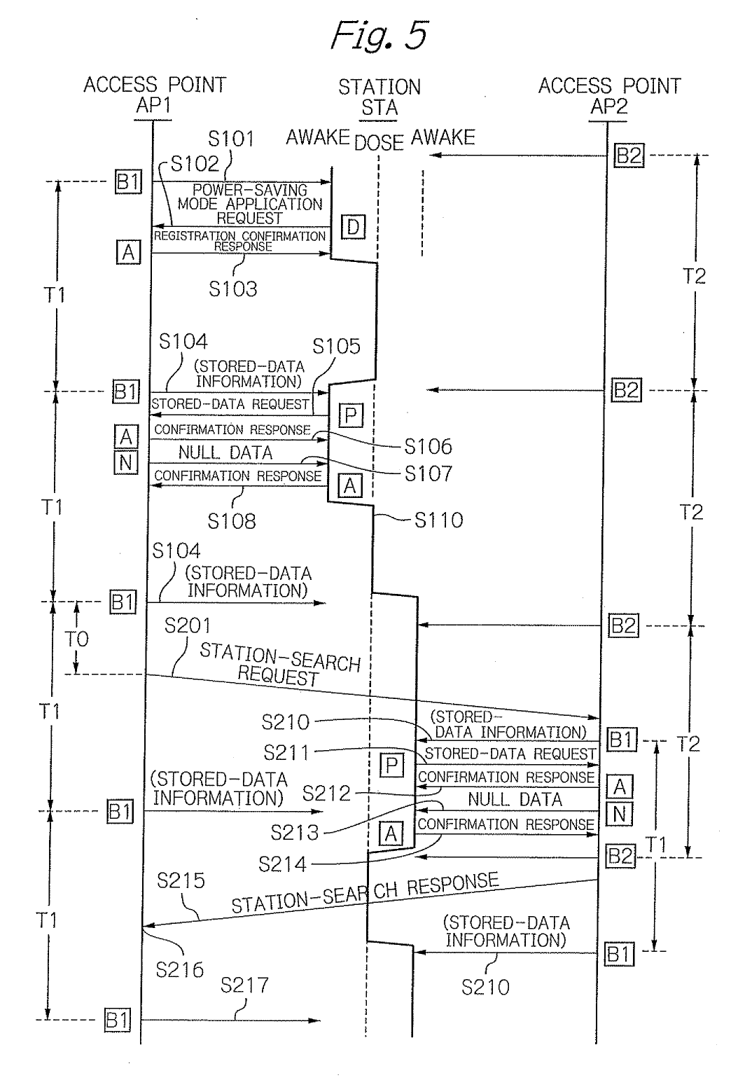

Now, FIG. 5 illustrates still another exemplified sequence of acquiring the positional information on a terminal station according to the present invention. This sequence may be the same as in FIG. 4 from step S101 until the station STA moves into the wireless area of the access point AP2, the access point AP1 fails to detect a response from the station STA to determine that the station STA has moved out of the area, and the access point AP1 sends the station-search request to other access point AP2, step S201. The access point AP1 then informs the access point AP2 of the information necessary for transmitting the beacon frame B1 as in the access point AP1, such as the address of the station STA to be searched for, the address and identification code of the access point AP1, and the area information of the access point AP1.

After receiving the station-search request, step S201, the access point AP2 transmits, instead of the access point AP1, the beacon frame B1 to the station STA, step S210. The beacon frame B1 contains the stored-data information which informs the station STA of the presence of the stored data for the station STA.

The station STA, which is now in the awake condition and waiting for the beacon frame B1, receives the beacon frame B1 transmitted from the accesspoint AP2. Thestation STA then checks the stored-data information for the stored data addressed to the station STA. Because the stored-data information indicates the presence of the stored data, in this example, the station STA transmits toward the access point AP1 (actually, to the access point AP2) a stored-data request frame P which requests the stored data to be transmitted, step S211.

The access point AP2 transmits, in response to the stored-data request frame P, a confirmation-response frame A and a null frame N to the station STA, steps S212 and S213. The station STA receives the null frame, and thereafter transmits a confirmation-response frame A toward the access point AP1 (actually, to the access point AP2), step S214, and returns to the dose condition.

The access point AP2 knows, when receiving the confirmation-response frame A from the station STA, that the station STA resides in its area, and transmits a station-search response to the access point AP1 over the extend wireless network ESS, step S215.

The access point AP1 recognizes, from the station-search response, that the station STA has moved out of the access point AP2 area. The access point AP1 then updates the positional information on the station STA to indicate that the station STA resides in the access point AP2 area, step S216. The access point AP2 still transmits, instead of the access point AP1, the beacon frame B1 toward the station STA at the constant transmission interval T1, step S217.

As described above, in the exemplified sequence of acquiring the positional information on a terminal station, when the access point AP1 fails to receive a stored-data request frame P from the station STA, it determines that the station STA has moved into another access point area, and searches for the station STA, and the access point AP2 to which the station STA has moved acts as a proxy of the access point AP1. The position of the station STA involved in the dose condition can thus always be grasped, thereby responding to the communication such as the voice communication which requires a quick response.

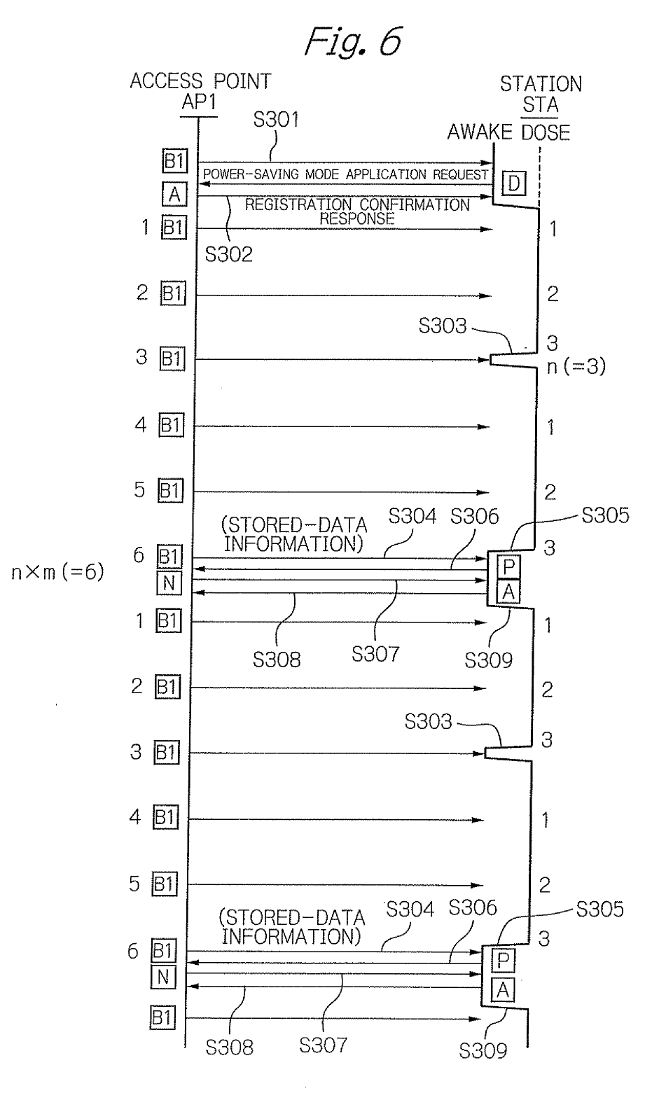

Well, FIG. 6 illustrates a further example of the power-saving control sequence of the wireless LAN according to the present invention. In the exemplified sequences shown in and described with reference to FIGS. 1, 4 and 5, the access point AP1 transmits the stored-data information at each timing of transmitting the beacon frame B1, step S104, and the station STA is shifted between its awake and dose conditions. That control sequences may be replaced with the power-saving control sequence shown in FIG. 6.

In the sequence shown in FIG. 6, the station STA sends a power-saving mode application request, step S301, and receives a registration confirmation response A, step S302. The station STA in turn enters its awake condition periodically at the timing of every first plurality of (n), e.g. three, beacons to wait for a beacon frame B1 transmitted from the access point AP1, step S303, where n is more generally a natural number. The access point AP1 registers the station STA involved in the power-saving mode. At the timing of every second plurality of (n×m), e.g. six (m=2) beacons, the access point AP1 periodically transmits the beacon frame B1 including the stored-data information which indicates the presence of the stored data for the station STA, step S304, regardless of whether or not the stored data exists. If the stored data for the station STA exists at the timing of every n beacons, however, the access point AP1 will transmit the beacon frame B1 including the stored-data information which indicates as such. In the illustrated embodiment, the value of m may be fixed as a system requirement, and the value of n may be set, at the registration of the station STA, for a particular mobile station depending on the exigency of the communication content or the like, or alternatively fixed as the system requirement.

As shown in FIG. 6, the station STA, when applied with the power-saving mode to be in the dose condition, will enter the awake condition at the timing of the third beacon frame B1, with the illustrative embodiment. Because the beacon frame B1 to be transmitted from the access point AP1 contains no stored-data information, the station STA immediately returns to the dose condition.

The station STA enters the awake condition at the timing of the next third beacon frame B1, step S305. The beacon frame B1 currently transmitted from the access point AP1 contains the stored-data information, and therefore the station STA, when received the beacon frame B1, checks the stored-data information in the frame for confirming whether or not data addressed to the station STA is stored. Because the stored-data information indicates the presence of the stored data addressed to the station STA, the station STA transmits to the access point AP1 the stored-data request frame P which requests the stored data to be transmitted, step S306.

The access point AP1 transmits, in response to the stored-data request frame P, stored data, if actually existing, in the form of data frame D, or transmits the null frame N, if no stored data exists, step S307. The data frame D contains the information about whether or not other stored data remains. Checking the information in the data frame D received, the station STA repeats transmitting the stored-data request frame P until the station STA receives all stored data. The station STA transmits, after having received all stored data or the null frame N, the confirmation-response frame A to the access point AP1, step S308, and returns to the dose condition, step S309.

In this way, the station STA enters the awake condition at the timing of everythree beacons, and remains in the dose condition at the timing of the first and second beacons, thus accomplishing the power-saving operation. The access point AP1 receives the stored-data request frame P transmitted from the station STA at the timing of every six beacons to confirm that the station STA resides in the area of the access point AP1.

As described above, in the exemplified power-saving control sequence, the station STA enters the awake condition at the timing of every n beacons to check for stored data, thereby attaining the lower power consumption than for a mobile station that would be adapted to enter the awake condition at the timing of every beacon. The access point AP1 transmits, at the timing of every n×m beacons, the stored-data information indicating the presence of the stored data, regardless of whether or not stored data exists. This can thus reduce the load and unnecessary frame transfer to avoid the deterioration of the system efficiency as compared with an access point which would be adapted to transmit stored-data information at the timing of every beacon.

Also referring to FIG. 6, the access point AP1 is adapted to return, immediately in response to the stored-data request frame P from the station STA, the null frame N without returning the confirmation-response frame A. This allows fewer frames to be transferred, further reducing the deterioration of the system efficiency.

The present invention is of course not limited to the above-described embodiment and the examples, but various modifications can be provided. For example, the sequence of acquiring the positional information on a terminal station has been described with respect to the wireless LAN as an example. It is however not limited to the wireless LAN, but applicable to any wireless systems which include an access point and mobile stations.

With the examples shown in and described with reference to FIGS. 4 and 5, the access point AP1 transmits the station-search request to other access points such as AP2 sequentially. The access point AP1 may alternatively be adapted to broadcast the station-search request to a plurality of access points. The access point AP1 can thus grasp the station position more quickly.

The stored-data request sequence is not limited to those described with reference to FIGS. 1 and 6. When no actual data is stored, the null data frame N is transmitted. Alternatively, for example, dummy data or a control frame may be transmitted to inform that no effective data is stored.

In the examples described with reference to FIGS. 1 and 4, when the station STA moves out of the wireless area, the deauthentication frame is transmitted to cancel the registration of the station STA. Alternatively, a control sequence using a disassociation frame or the like may be applicable to cancelling the registration of the station STA, for example.

The entire disclosure of Japanese patent application No. 2005-235904 filed on Aug. 16, 2005, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modifythe embodiments without departing from the scope and spirit of the present invention.

What is claimed is:

1. A method for acquiring positional information on a wireless terminal station in a wireless communication system, comprising the steps of:
preparing a wireless communication system including an access point and a plurality of wireless terminal stations communicating with the access point;
transmitting a beacon frame from the access point at a predetermined interval;
setting the wireless terminal stations to a power-saving mode;
allowing the wireless terminal stations to enter a normal-operation mode at a timing of the beacon frame being transmitted to receive the beacon frame;
transmitting from the access point the beacon frame including stored-data information indicating presence of stored data addressed to one of the wireless terminal stations which is set to the power-saving mode, regardless of whether or not the stored data exists;
sending a stored-data transmission request from the one wireless terminal station to the access point when the stored-data information in the beacon frame indicates the presence of the stored data addressed to the one wireless terminal station;
receiving the stored-data information by the one wireless terminal station, and transmitting a stored data transmission request to the access point;
receiving the stored data transmission request by the access point, and recognizing the presence of the one wireless terminal station;
transmitting from the access point the stored data if the stored data actually exists, or dummy data if no data is stored;
receiving the stored data or the dummy data transmitted from the access point by the one wireless terminal station;
allowing the one wireless station to return to the power-saving mode;
allowing the access point to determine, when failing to receive the stored data transmission request from the one wireless terminal station within a predetermined period of time after transmitting the beacon frame, that the one wireless terminal station has moved out of a wireless service area of the access point; and
deleting registration of the one wireless terminal station from the access point.

2. The method according to any one of claim 1, further comprising the steps of:
allowing the wireless terminal station set to the power-saving mode to enter, atatimingofevery n beacon frames, where n is anaturalnumber, thenormal-operationmodetoreceive the beacon frame;
transmitting from the access point setting the power-saving mode, at a timing of every n×m beacon frames, where m is a natural number, the beacon frame including the stored-data information indicating the presence of the stored data addressed to the wireless terminal station set to the power-saving mode, regardless of whether or not the stored data exists.

3. A method for acquiring positional information on a wireless terminal station in a wireless communication system, comprising the steps of:
preparing a wireless communication system including a plurality of access points and a plurality of wireless terminal stations communicating with the access point;
transmitting abeacon frame fromoneoftheaccesspoints at a predetermined interval;
setting the wireless terminal stations to a power-saving mode;
allowing the wireless terminal stations to enter a normal-operation mode at a timing of the beacon frame being transmitted to receive the beacon frame;
transmitting from the one access point the beacon frame including stored-data information indicating presence of stored data addressed to one of the wireless terminal stations which is set to the power-saving mode, regardless of whether or not the stored data exists;
sending a stored-data transmission request from the one wireless terminal station to the one access point when the stored-data information in the beacon frame indicates the presence of the stored data addressed to the one wireless terminal station;
receiving the stored-data information by the one wireless terminal station, and transmitting a stored data transmission request to the one access point;
receiving the stored data transmission request by the one access point, and recognizing the presence of the one wireless terminal station;
transmitting from the one access point the stored data if the stored data actually exists, or dummy data if no data is stored;
receiving the stored data or the dummy data transmitted from the one access point by the one wireless terminal station;
allowing the one wireless station to return to the power-saving mode;
allowing the one access point to determine, when failing to receive the stored data transmission request from the one wireless terminal station within a predetermined period of time after transmitting the beacon frame, that the one wireless terminal station has moved out of a wireless service area of the one access point;
requesting another of the access points by the one access point to search for the one wireless terminal station;
receiving a search result of the one wireless terminal station in a form of response from the other access point; and
allowing the one access point to acquire positional information on the one wireless terminal station based on the response.

4. The method according to claim 3, wherein said step of requesting the other access point to search for the one wireless terminal station comprises the step of allowing the one access point to request the other access point to cancel the registration of the one wireless terminal station.

5. The method according to claim 3, wherein said step of requesting the other access point to search for the one wireless terminal station comprises the step of allowing the one access point to request the other access point to transmit the beacon frame as a proxy of the one access point.

6. The method according to any one of claim 3, further comprising the steps of:
allowing the one wireless terminal station set to the power-saving mode to enter, at a timing of every n beacon frames, where n is a natural number, the normal-operation mode to receive the beacon frame;
transmitting from the one access point setting the power-saving mode, at a timing of every n×m beacon frames, where m is a natural number, the beacon frame including the stored-data information indicating the presence of the stored data addressed to the one wireless terminal station set to the power-saving mode, regardless of whether or not the stored data exists.
